(19) United States
(12) Patent Application Publication
(10) Pub. No.: US 2025/0124693 A1
(43) Pub. Date: Apr. 17, 2025

(54) DATA AUGMENTATION

(71) Applicant: Beijing Youzhuju Network Technology Co., Ltd., Beijing (CN)

(72) Inventors: Jingling Li, Los Angeles, CA (US); Xiaoyu Liu, Los Angeles, CA (US)

(21) Appl. No.: 18/988,432

(22) Filed: Dec. 19, 2024

(51) Int. Cl. G06V 10/774

(52) U.S. Cl. CPC G06V 10/774

(57) ABSTRACT

Embodiments of the present disclosure provide a solution for data augmentation. A method includes: obtaining one or more candidate descriptions of an image with respect to a question associated with the image; determining a target description from the one or more candidate descriptions based on respective effectiveness metrics of the one or more candidate descriptions, an effectiveness metric of a candidate description indicating whether the candidate description is useful in answering the question; and constructing a training sample for a machine learning model, the training sample comprising the image, the question and the target description.

### FIELD

The present disclosure generally relates to computer technologies, and more specifically, to a method, apparatus, device and computer readable storage medium for data augmentation.

### BACKGROUND

Vision Language Models (VLMs) are designed to understand and generate text about visual content by integrating techniques from both computer vision and natural language processing. VLMs typically use large-scale datasets containing image-text pairs to learn the correlation between visual and textual information. However, it is observed that VLMs may still output incorrect answers even under circumstances where they can understand the input image to the extent that they may answer correctly.

### SUMMARY

In a first aspect of the present disclosure, there is provided a method of data augmentation. The method comprises: obtaining one or more candidate descriptions of an image with respect to a question associated with the image; determining a target description from the one or more candidate descriptions based on respective effectiveness metrics of the one or more candidate descriptions, an effectiveness metric of a candidate description indicating whether the candidate description is useful in answering the question; and constructing a training sample for a machine learning model, the training sample comprising the image, the question and the target description.

In a second aspect of the present disclosure, there is provided an apparatus for data augmentation. The apparatus comprises: a description obtaining module configured to obtain one or more candidate descriptions of an image with respect to a question associated with the image; a target description determining module configured to determine a target description from the one or more candidate descriptions based on respective effectiveness metrics of the one or more candidate descriptions, an effectiveness metric of a candidate description indicating whether the candidate description is useful in answering the question; and a training sample constructing module configured to construct a training sample for a machine learning model, the training sample comprising the image, the question and the target description.

In a third aspect of the present disclosure, there is provided an electronic device. The electronic device comprises: at least one processing unit; and at least one memory coupled to the at least one processing unit and storing instructions executable by the at least one processing unit, the instructions, upon execution by the at least one processing unit, causing the electronic device to perform: obtaining one or more candidate descriptions of an image with respect to a question associated with the image; determining a target description from the one or more candidate descriptions based on respective effectiveness metrics of the one or more candidate descriptions, an effectiveness metric of a candidate description indicating whether the candidate description is useful in answering the question; and constructing a training sample for a machine learning model, the training sample comprising the image, the question and the target description.

In a fourth aspect of the present disclosure, a computer-readable storage medium is provided. The computer-readable storage medium stores computer executable instructions which, when executed by an electronic device, causes the electronic device perform operations comprising: obtaining one or more candidate descriptions of an image with respect to a question associated with the image; determining a target description from the one or more candidate descriptions based on respective effectiveness metrics of the one or more candidate descriptions, an effectiveness metric of a candidate description indicating whether the candidate description is useful in answering the question; and constructing a training sample for a machine learning model, the training sample comprising the image, the question and the target description.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE SEVERAL VIEWS OF THE DRAWINGS

The above and other features, advantages and aspects of the embodiments of the present disclosure will become more apparent in combination with the accompanying drawings and with reference to the following detailed description. In the drawings, the same or similar reference symbols refer to the same or similar elements, where:

FIG. 1 illustrates a schematic diagram of an example environment in which embodiments of the present disclosure may be implemented;

FIG. 2 illustrates a schematic diagram of data augmentation in accordance with some embodiments of the present disclosure;

FIG. 3 illustrates a flowchart of a process for data augmentation in accordance with some embodiments of the present disclosure;

FIG. 4 shows a block diagram of an apparatus for data augmentation in accordance with some embodiments of the present disclosure; and

FIG. 5 illustrates a block diagram of an electronic device in which one or more embodiments of the present disclosure can be implemented.

### DETAILED DESCRIPTION

The embodiments of the present disclosure will be described in more detail below with reference to the accompanying drawings. Although some embodiments of the present disclosure are shown in the drawings, it would be appreciated that the present disclosure may be implemented in various forms and should not be interpreted as limited to the embodiments described herein. On the contrary, these embodiments are provided for a more thorough and complete understanding of the present disclosure. It would be appreciated that the drawings and embodiments of the present disclosure are only for the purpose of illustration and are not intended to limit the scope of protection of the present disclosure.

In the description of the embodiments of the present disclosure, the term “including” and similar terms would be appreciated as open inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below. As used herein, the term “model” can represent the matching degree between various data. For example, the above matching degree can be obtained based on various technical solutions currently available and/or to be developed in the future.

It will be appreciated that the data involved in this technical proposal (including but not limited to the data itself, data acquisition or use) shall comply with the requirements of corresponding laws, regulations and relevant provisions.

It will be appreciated that before using the technical solution disclosed in each embodiment of the present disclosure, users should be informed of the type, the scope of use, the use scenario, etc. of the personal information involved in the present disclosure in an appropriate manner in accordance with relevant laws and regulations, and the user's authorization should be obtained.

For example, in response to receiving an active request from a user, a prompt message is sent to the user to explicitly prompt the user that the operation requested operation by the user will need to obtain and use the user's personal information. Thus, users may select whether to provide personal information to the software or the hardware such as an electronic device, an application, a server or a storage medium that perform the operation of the technical solution of the present disclosure according to the prompt information.

As an optional but non-restrictive implementation, in response to receiving the user's active request, the method of sending prompt information to the user may be, for example, a pop-up window in which prompt information may be presented in text. In addition, pop-up windows may also contain selection controls for users to choose “agree” or “disagree” to provide personal information to electronic devices.

It will be appreciated that the above notification and acquisition of user authorization process are only schematic and do not limit the implementations of the present disclosure. Other methods that meet relevant laws and regulations may also be applied to the implementation of the present disclosure.

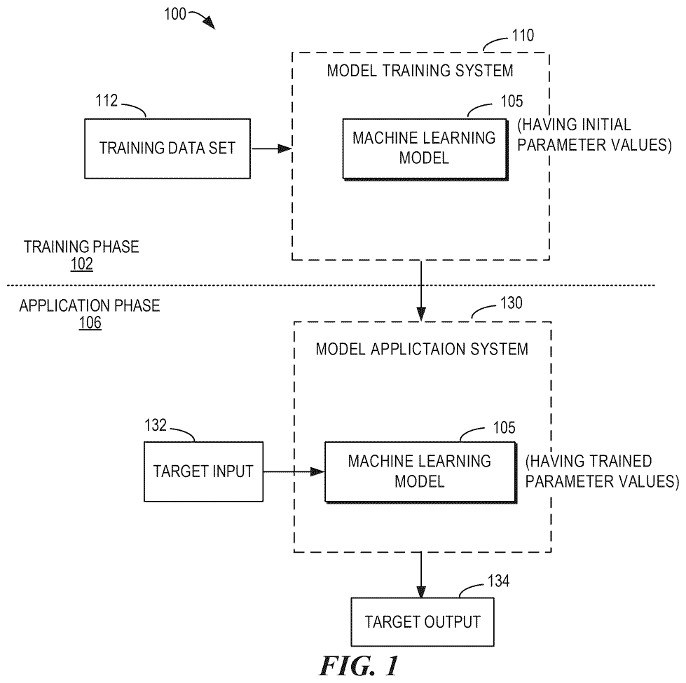

FIG. 1 illustrates a block diagram of an example environment 100 in which various embodiments of the present disclosure may be implemented. In the environment 100 of FIG. 1, two distinct phases of a model are showed, including a training phase 102 and an application phase 106. After the training phase 102 is completed, there may be a testing phase, which is not shown in FIG. 1.

In the training phase 102, a model training system 110 is configured to utilize a training dataset 112 to perform training of the machine learning model 105. At the beginning of training, the machine learning model 105 may have initial parameter values. The training process is to update the parameter values of the machine learning model 105 to the expected values based on the training data. In some embodiments, the machine learning model 105 is configured to generate a watermarked text.

In the application phase 106, the machine learning model 105 having trained parameter values may be provided to a model application system 130 for use. In the application phase 106, the machine learning model 105 may be used to process a target input 132 and provide a corresponding target output 134.

In FIG. 1, the model training system 110 and the model application system 130 may be implemented at any computing system with computing capability, such as various computing devices/systems, terminal devices, servers, etc. Terminal devices may include any type of mobile terminals, fixed terminals, or portable terminals, including mobile phones, desktop computers, laptops, netbooks, tablets, media computers, multimedia tablets, or any combination of the aforementioned, including accessories and peripherals of these devices or any combination thereof. Servers include but are not limited to mainframe, edge computing nodes, computing devices in cloud environment, etc.

It should be understood that the structure and function of each element in the environment 100 is described for illustrative purposes only and does not imply any limitations on the scope of the present disclosure. In an example, although shown as separate, the model training system 110 and the model application system 130 may be integrated into a same system or device. The implementation method disclosed herein is not limited in this regard.

As briefly mentioned above, VLMs may output incorrect answers. The datasets used for training VLMs are diverse and large-scale, often sourced from the internet. In some conventional solutions, a dataset contains annotated images with multiple captions. Another dataset comprises millions of image-caption pairs extracted from web pages. Despite the rapid growth of datasets, it is observed that VLMs may still output incorrect answers even under circumstances where they can understand the input image to the extent that they can answer correctly. It seems that despite VLMs having a good level of understanding of the image data and image-text alignment, there is still great room for improvement in aligning focus or attention when dealing with specific questions, which is beyond general image captioning. At this point, from a data-driven perspective, it is desired to align VLMs with specific contents in the input that are useful to a given question.

Embodiments of the present disclosure propose an improved solution for data augmentation. In this solution, one or more candidate descriptions of an image with respect to a question associated with the image are obtained. A target description is determined from the one or more candidate descriptions based on respective effectiveness metrics of the one or more candidate descriptions. An effectiveness metric of a candidate description indicates whether the candidate description is useful in answering the question. A training sample for a machine learning model is constructed. The training sample comprises the image, the question and the target description.

With these embodiments of the present disclosure, training samples comprising the target description are constructed from the machine learning model without using or collecting any new data. In this way, the number of training samples may be increased and the machine learning model trained with augmented data may show improvements in performance metrics.

Example embodiments of the present disclosure will be described with reference to the drawings.

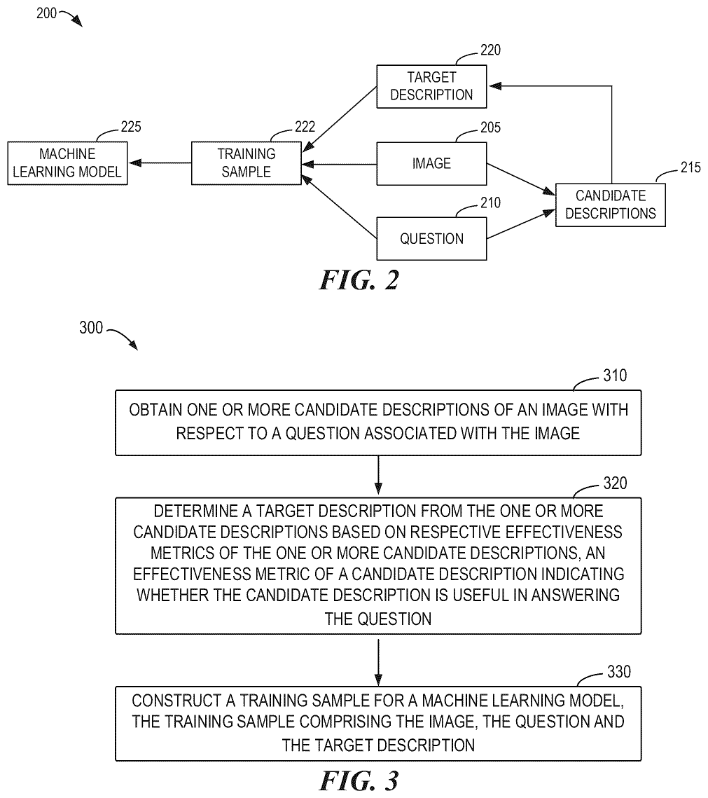

FIG. 2 illustrates a schematic diagram 200 of data augmentation in accordance with some embodiments of the present disclosure. In some examples, data augmentation may be used to augment training samples to train a machine learning model. As shown in FIG. 2, one or more candidate descriptions 215 of an image 205 with respect to a question 210 associated with the image 205 are obtained. In some examples, the one or more candidate descriptions 215 may be generated automatically or manually.

In some embodiments, a machine learning model 225 (e.g., VLM) may be used to generate the one or more candidate descriptions 215 (also referred to as question-oriented descriptions) based on the question 210 and the image 205. With these embodiments, text descriptions of the given image that help to answer the question may be obtained. In this way, the machine learning model may output more correct answers.

In some embodiments, a prompt may be input to the machine learning model 225 to generate the one or more candidate descriptions 215. Firstly, a prompt instructing the machine learning model 225 to provide a description in assistance of answering the question 210 may be provided. In some examples, the prompt may be “Can you provide a description that could help answer the following question: {question}”. Then, the prompt may be provided to the machine learning model 225 to obtain a model output from the machine learning model 225. The one or more candidate descriptions 215 may be determined based on the model output. In some examples, some processing may be performed on the model output to determine the one or more candidate descriptions 215.

After the one or more candidate descriptions 215 are generated, a target description 220 is determined from the one or more candidate descriptions 215 based on respective effectiveness metrics of the one or more candidate descriptions 215. The effectiveness metric of a candidate description indicates whether the candidate description is useful in answering the question 210. In some examples, if an effectiveness metric of a candidate description indicates the candidate description is useful in answering the question 210, the candidate description may be determined as the target description 220.

In some embodiments, for a given candidate description of the one or more candidate descriptions 215, an answer for the question may be obtained using a machine learning model 225 and based on the question 210 and the given candidate description. Then, whether the obtained answer is correct may be determined. If the obtained answer is correct, the given candidate description may be determined as the target description. In some examples, the question may include at least one of: a multiple-choice question or an essay question.

In some embodiments, regarding the multiple-choice question, the question 210 and a plurality of candidate answers (e.g., A, B, C and D) to the question 210 may be provided to the machine learning model 225. A candidate answer selected by the machine learning model may be determined as the obtained answer.

In some embodiments, at least one candidate answer of the plurality of candidate answers is a correct answer to the question. If the obtained answer is one of the at least one candidate answer, it is determined that the obtained answer is correct. With these embodiments, whether the obtained answer is correct may be directly determined without manual intervention because the correct answer may be preset for the multiple-choice question. In this way, the efficiency of determining whether the obtained answer is correct may be improved.

In some embodiments, regarding the essay question, the machine learning model 225 may generate a piece of text as the obtained answer for the question 210. In some examples, some other trained machine learning models (for example, a machine learning model trained to perform essay evaluation) may be used to determine whether the obtained answer is correct. Alternatively, whether the obtained answer is correct may be determined manually.

In some embodiments, the answer may be generated without providing the image to the machine learning model. In some examples, only the question 210 and the given candidate description may be provided to the machine learning model 225 to generate the answer. With these embodiments, the correct answer may be generated without the image 205, this helps guarantee that the generated description will be helpful to the training or finetuning process.

After the target description 220 is determined, a training sample 222 for the machine learning model 225 is constructed. The training sample 222 comprises the image 205, the question 210 and the target description 215. In some examples, it is hypothesized that if the machine learning model 225 can answer the question 110 correctly using only the generated task-specific description (also referred to as the target description 215) and the answer has some explanations, then this generated triplet which includes the image 205, the question 210 and the target description 215 may be helpful in training the machine learning model 225.

In some embodiments, if the machine learning model 225 is pretrained, the training sample 222 may be used to finetune the machine learning model 225. The target description 215 may be regarded as the ground truth description.

In some embodiments, a predicted description may be generated, using the machine learning model, based on the image 205 and the question 210. A difference (also referred to as loss) between the predicted description and target description 215 may be determined. Then, the machine learning model may be updated based on the difference. In some examples, the machine learning model may be updated based on a predetermined objective and the predetermined objective is configured to minimize or reduce the difference.

In some embodiments, the above procedure may be iteratively performed until the improvements of the machine learning model 225 start to saturate. In this way, a self-improvement loop may be enabled and the performance of the machine learning model 225 is continuously enhanced.

In some embodiments, a general description may be obtained for a given image. For example, a prompt “Can you describe the given image” may be provided to the machine learning model 225 to generate the general description. Then, the machine learning model 225 may output an answer based on a question and the general description. The visual question answering (VQA) accuracy of the machine learning model 225 may be evaluated in different scenarios. In a first scenario, the input to the machine learning model 225 is the question 210 and the image 205. The machine learning model 225 outputs an answer to the question 210. In a second scenario, the input to the machine learning model 225 is the question 210 and a general description. The machine learning model 225 outputs an answer to the question 210. In a third scenario, the input to the machine learning model 225 is the question 210 and a question-oriented description (as an example of the target description 220). The machine learning model 225 outputs an answer to the question 210. The VQA accuracy of the machine learning model 225 in the third scenario is higher than the first and the second scenario.

FIG. 3 illustrates a flowchart of a process 300 for data augmentation in accordance with some embodiments of the present disclosure. The process 300 may be implemented at the model training system 110 of FIG. 1.

At block 310, the model training system 110 obtains one or more candidate descriptions of an image with respect to a question associated with the image.

At block 320, the model training system 110 determines a target description from the one or more candidate descriptions based on respective effectiveness metrics of the one or more candidate descriptions. An effectiveness metric of a candidate description indicates whether the candidate description is useful in answering the question.

At block 330, the model training system 110 constructs a training sample for a machine learning model, the training sample comprising the image, the question and the target description.

In some embodiments, determining the target description from the one or more candidate descriptions comprises: for a given candidate description of the one or more candidate descriptions, obtaining, using the machine learning model, an answer for the question based on the question and the given candidate description; determining whether the obtained answer is correct; and in accordance with a determination that the obtained answer is correct, determining the given candidate description as the target description.

In some embodiments, the answer for the question is obtained by: providing, to the machine learning model, the question and a plurality of candidate answers to the question; and determining, as the obtained answer, a candidate answer selected by the machine learning model.

In some embodiments, at least one candidate answer of the plurality of candidate answers is a correct answer to the question, and determining whether the obtained answer is correct comprises: in accordance with a determination that the obtained answer is one of the at least one candidate answer, determining that the obtained answer is correct.

In some embodiments, the answer is generated without providing the image to the machine learning model.

In some embodiments, obtaining the one or more candidate descriptions comprises: generating, using the machine learning model, the one or more candidate descriptions based on the question and the image.

In some embodiments, generating the one or more candidate descriptions comprises: generating, based on the question, a prompt instructing the machine learning model to provide a description in assistance of answering the question; providing the prompt to the machine learning mode to obtain a model output from the machine learning model; and determining the one or more candidate descriptions based on the model output.

In some embodiments, the machine learning model is trained by: generating, using the machine learning model, a predicted description based on the image and the question; determining a difference between the predicted description and the target description; and updating the machine learning model based on the difference.

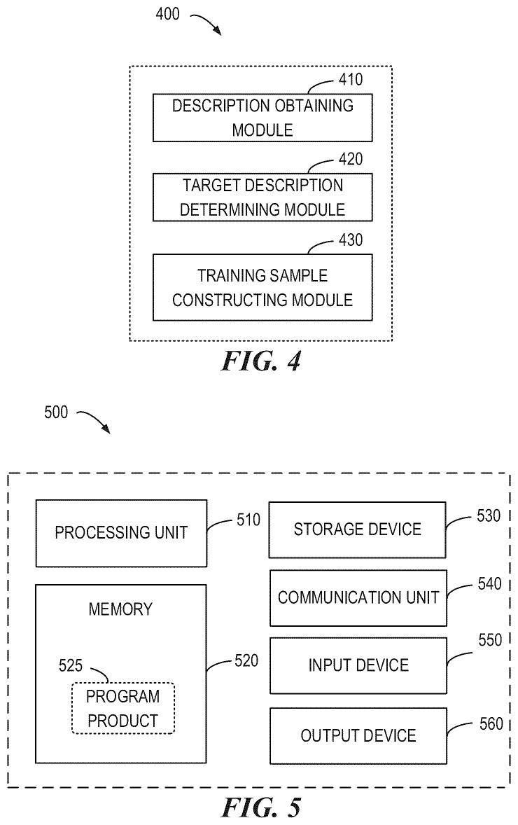

FIG. 4 shows a block diagram of an apparatus 400 for data augmentation in accordance with some embodiments of the present disclosure. The apparatus 400 may be implemented, for example, or included at the model training system 110 of FIG. 1. Various modules/components in the apparatus 400 may be implemented by hardware, software, firmware, or any combination thereof.

As illustrated, the apparatus 400 includes a description obtaining module 410 configured to obtain one or more candidate descriptions of an image with respect to a question associated with the image.

The apparatus 400 includes a target description determining module 420 configured to determine a target description from the one or more candidate descriptions based on respective effectiveness metrics of the one or more candidate descriptions. An effectiveness metric of a candidate description indicating whether the candidate description is useful in answering the question.

The apparatus 400 further includes a training sample constructing module 430 configured to construct a training sample for a machine learning model, the training sample comprising the image, the question and the target description.

In some embodiments, the target description determining module 420 is further configured to, for a given candidate description of the one or more candidate descriptions, obtain, using the machine learning model, an answer for the question based on the question and the given candidate description; determine whether the obtained answer is correct; and in accordance with a determination that the obtained answer is correct, determine the given candidate description as the target description.

In some embodiments, the answer for the question is obtained by: providing, to the machine learning model, the question and a plurality of candidate answers to the question; and determining, as the obtained answer, a candidate answer selected by the machine learning model.

In some embodiments, at least one candidate answer of the plurality of candidate answers is a correct answer to the question. The target description determining module 420 is further configured to, in accordance with a determination that the obtained answer is one of the at least one candidate answer, determine that the obtained answer is correct.

In some embodiments, the answer is generated without providing the image to the machine learning model.

In some embodiments, the description obtaining module 410 is further configured to generate, using the machine learning model, the one or more candidate descriptions based on the question and the image.

In some embodiments, the description obtaining module 410 is further configured to generate, based on the question, a prompt instructing the machine learning model to provide a description in assistance of answering the question; provide the prompt to the machine learning mode to obtain a model output from the machine learning model; and determine the one or more candidate descriptions based on the model output.

In some embodiments, the machine learning model is trained by: generating, using the machine learning model, a predicted description based on the image and the question; determining a difference between the predicted description and the target description; and updating the machine learning model based on the difference.

FIG. 5 illustrates a block diagram of an electronic device 500 in which one or more embodiments of the present disclosure can be implemented. It would be appreciated that the electronic device 500 shown in FIG. 5 is only an example and should not constitute any restriction on the function and scope of the embodiments described herein. The electronic device 500 may be used, for example, to implement the model training system 110 of FIG. 1. The electronic device 500 may also be used to implement the apparatus 400 of FIG. 4.

As shown in FIG. 5, the electronic device 500 is in the form of a general computing device. The components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and can execute various processes according to the programs stored in the memory 520. In a multiprocessor system, multiple processing units execute computer executable instructions in parallel to improve the parallel processing capability of the electronic device 500.

The electronic device 500 typically includes a variety of computer storage medium. Such medium may be any available medium that is accessible to the electronic device 500, including but not limited to volatile and non-volatile medium, removable and non-removable medium. The memory 520 may be volatile memory (for example, a register, cache, a random access memory (RAM)), a non-volatile memory (for example, a read-only memory (ROM), an electrically erasable programmable read-only memory (EEPROM), a flash memory) or any combination thereof. The storage device 530 may be any removable or non-removable medium, and may include a machine-readable medium, such as a flash drive, a disk, or any other medium, which can be used to store information and/or data (such as training data for training) and can be accessed within the electronic device 500.

The electronic device 500 may further include additional removable/non-removable, volatile/non-volatile, transitory/non-transitory storage medium. Although not shown in FIG. 5, a disk driver for reading from or writing to a removable, non-volatile disk (such as a “floppy disk”), and an optical disk driver for reading from or writing to a removable, non-volatile optical disk can be provided. In these cases, each driver may be connected to the bus (not shown) by one or more data medium interfaces. The memory 520 may include a computer program product 525, which has one or more program modules configured to perform various methods or acts of various embodiments of the present disclosure.

The communication unit 540 communicates with a further computing device through the communication medium. In addition, functions of components in the electronic device 500 may be implemented by a single computing cluster or multiple computing machines, which can communicate through a communication connection. Therefore, the electronic device 500 may be operated in a networking environment using a logical connection with one or more other servers, a network personal computer (PC), or another network node.

The input device 550 may be one or more input devices, such as a mouse, a keyboard, a trackball, etc. The output device 560 may be one or more output devices, such as a display, a speaker, a printer, etc. The electronic device 500 may also communicate with one or more external devices (not shown) through the communication unit 540 as required. The external device, such as a storage device, a display device, etc., communicate with one or more devices that enable users to interact with the electronic device 500, or communicate with any device (for example, a network card, a modem, etc.) that makes the electronic device 500 communicate with one or more other computing devices. Such communication may be executed via an input/output (I/O) interface (not shown).

According to example implementation of the present disclosure, a computer-readable storage medium is provided, on which a computer-executable instruction or computer program is stored, where the computer-executable instructions or the computer program is executed by the processor to implement the method described above. According to example implementation of the present disclosure, a computer program product is also provided. The computer program product is physically stored on a non-transient computer-readable medium and includes computer-executable instructions, which are executed by the processor to implement the method described above.

Various aspects of the present disclosure are described herein with reference to the flow chart and/or the block diagram of the method, the device, the equipment and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, special computers or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device and/or other devices to work in a specific way. Therefore, the computer-readable medium containing the instructions includes a product, which includes instructions to implement various aspects of the functions/acts specified in one or more blocks in the flowchart and/or the block diagram.

The computer-readable program instructions may be loaded onto a computer, other programmable data processing apparatus, or other devices, so that a series of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is example, not exhaustive, and is not limited to the disclosed implementations. Without departing from the scope and spirit of the described implementations, many modifications and changes are obvious to ordinary skill in the art. The selection of terms used in this article aims to best explain the principles, practical application or improvement of technology in the market of each implementation, or to enable other ordinary skill in the art to understand the various embodiments disclosed herein.

What is claimed is:

1. A method for data augmentation, comprising:
obtaining one or more candidate descriptions of an image with respect to a question associated with the image;
determining a target description from the one or more candidate descriptions based on respective effectiveness metrics of the one or more candidate descriptions, an effectiveness metric of a candidate description indicating whether the candidate description is useful in answering the question; and
constructing a training sample for a machine learning model, the training sample comprising the image, the question and the target description.

2. The method of claim 1, wherein determining the target description from the one or more candidate descriptions comprises:
for a given candidate description of the one or more candidate descriptions,
obtaining, using the machine learning model, an answer for the question based on the question and the given candidate description;
determining whether the obtained answer is correct; and
in accordance with a determination that the obtained answer is correct, determining the given candidate description as the target description.

3. The method of claim 2, wherein the answer for the question is obtained by:
providing, to the machine learning model, the question and a plurality of candidate answers to the question; and
determining, as the obtained answer, a candidate answer selected by the machine learning model.

4. The method of claim 3, wherein at least one candidate answer of the plurality of candidate answers is a correct answer to the question, and determining whether the obtained answer is correct comprises:
in accordance with a determination that the obtained answer is one of the at least one candidate answer, determining that the obtained answer is correct.

5. The method of claim 2, wherein the answer is generated without providing the image to the machine learning model.

6. The method of claim 1, wherein obtaining the one or more candidate descriptions comprises:
generating, using the machine learning model, the one or more candidate descriptions based on the question and the image.

7. The method of claim 6, wherein generating the one or more candidate descriptions comprises:
generating, based on the question, a prompt instructing the machine learning model to provide a description in assistance of answering the question;
providing the prompt to the machine learning mode to obtain a model output from the machine learning model; and
determining the one or more candidate descriptions based on the model output.

8. The method of claim 1, wherein the machine learning model is trained by:
generating, using the machine learning model, a predicted description based on the image and the question;
determining a difference between the predicted description and the target description; and
updating the machine learning model based on the difference.

9. An electronic device, comprising:
at least one processing unit; and
at least one memory coupled to the at least one processing unit and storing instructions executable by the at least one processing unit, the instructions, upon execution by the at least one processing unit, causing the electronic device to perform operations comprising:
obtaining one or more candidate descriptions of an image with respect to a question associated with the image;
determining a target description from the one or more candidate descriptions based on respective effectiveness metrics of the one or more candidate descriptions, an effectiveness metric of a candidate description indicating whether the candidate description is useful in answering the question; and
constructing a training sample for a machine learning model, the training sample comprising the image, the question and the target description.

10. The electronic device of claim 9, wherein determining the target description from the one or more candidate descriptions comprises:
for a given candidate description of the one or more candidate descriptions,
obtaining, using the machine learning model, an answer for the question based on the question and the given candidate description;
determining whether the obtained answer is correct; and
in accordance with a determination that the obtained answer is correct, determining the given candidate description as the target description.

11. The electronic device of claim 10, wherein the answer for the question is obtained by:
providing, to the machine learning model, the question and a plurality of candidate answers to the question; and
determining, as the obtained answer, a candidate answer selected by the machine learning model.

12. The electronic device of claim 11, wherein at least one candidate answer of the plurality of candidate answers is a correct answer to the question, and determining whether the obtained answer is correct comprises:
in accordance with a determination that the obtained answer is one of the at least one candidate answer, determining that the obtained answer is correct.

13. The electronic device of claim 10, wherein the answer is generated without providing the image to the machine learning model.

14. The electronic device of claim 9, wherein obtaining the one or more candidate descriptions comprises:
generating, using the machine learning model, the one or more candidate descriptions based on the question and the image.

15. The electronic device of claim 14, wherein generating the one or more candidate descriptions comprises:
generating, based on the question, a prompt instructing the machine learning model to provide a description in assistance of answering the question;
providing the prompt to the machine learning mode to obtain a model output from the machine learning model; and
determining the one or more candidate descriptions based on the model output.

16. The electronic device of claim 9, wherein the machine learning model is trained by:
generating, using the machine learning model, a predicted description based on the image and the question;
determining a difference between the predicted description and the target description; and
updating the machine learning model based on the difference.

17. A non-transitory computer readable storage medium having computer executable instructions stored thereon, the computer executable instructions, when executed by an electronic device, causing the electronic device perform operations comprising:
obtaining one or more candidate descriptions of an image with respect to a question associated with the image;
determining a target description from the one or more candidate descriptions based on respective effectiveness metrics of the one or more candidate descriptions, an effectiveness metric of a candidate description indicating whether the candidate description is useful in answering the question; and
constructing a training sample for a machine learning model, the training sample comprising the image, the question and the target description.

18. The non-transitory computer readable storage medium of claim 17, wherein determining the target description from the one or more candidate descriptions comprises:
for a given candidate description of the one or more candidate descriptions,
obtaining, using the machine learning model, an answer for the question based on the question and the given candidate description;
determining whether the obtained answer is correct; and
in accordance with a determination that the obtained answer is correct, determining the given candidate description as the target description.

19. The non-transitory computer readable storage medium of claim 18, wherein the answer for the question is obtained by:
providing, to the machine learning model, the question and a plurality of candidate answers to the question; and
determining, as the obtained answer, a candidate answer selected by the machine learning model.

20. The non-transitory computer readable storage medium of claim 19, wherein at least one candidate answer of the plurality of candidate answers is a correct answer to the question, and determining whether the obtained answer is correct comprises:
in accordance with a determination that the obtained answer is one of the at least one candidate answer, determining that the obtained answer is correct.
